(19) United States
(12) Patent Application Publication
(10) Pub. No.: US 2008/0079673 A1
(43) Pub. Date: Apr. 3, 2008

(54) Driving method for LCD and apparatus thereof

(75) Inventors: Kuan-Hung Liu, Padeh City (TW); Ming-Wei Huang, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/594,820

(22) Filed: Nov. 9, 2006

(30) Foreign Application Priority Data
Sep. 29, 2006 (TW) 95136265

(51) Int. Cl. G09G 3/36

(52) U.S. Cl. 345/87

(57) ABSTRACT

A driving method and the apparatus thereof are provided based on the response characteristics of liquid crystal. A first and a second scans are executed during a frame time. During the execution of the first scan, the liquid crystal is twisted in response to an over-driving voltage to reach an angle corresponding to a target gray level within a first display period. During the execution of the second scan, a voltage corresponding to a black frame is applied to the liquid crystal within a second display period. The first and second display periods are within the frame interval, respectively, and may be modulated to have a sum equal to the frame period.

### BACKGROUND OF THE INVENTION

1. Field of the Invention

The present invention relates to a driving method and apparatus of a display, and more especially, to a driving method and apparatus of a liquid crystal display.

2. Background of the Related Art

Liquid crystal display has replaced cathode ray tube (CRT) to become mainstream of display nowadays. Considered a display mode, an impulse type is applied on the conventional cathode ray tube. Shown in FIG. 1, L1 presents the curve of light's on-off with the impulse type. A pixel presents a required luminance in response to electrical impulsion and then becomes dark. On the other hand, a hold type is applied on a liquid crystal display. Shown in FIG. 2, after the pixel electrodes are charged up to a required voltage (shown as D1), liquid crystals may be gradually twisted to corresponding angles so that light from a backlight may pass through the twisted liquid crystals to generate brightness in corresponding gray level (shown as L2). That is, in a normal display mode of TFT-LCD, when a required voltage is imposed on a gate to electrically connect a thin film transistor, a pixel electrode may be charged up to the required voltage. In the meantime, the liquid crystals are twisted and tilted in response to the required voltage, which may enable the light of backlight to pass through in different degrees to generate various color. The general response time of various conditions (from one gray level to another one) is mostly longer than a frame interval (e.g. 16 ms).

The differences in the aforementioned display modes and configuration result in more sensibly blurry effects than conventional CRT when LCD displays a dynamic frame. In order to improve the hold type LCD, over driving is utilized to reduce the response time of liquid crystals for the improvements on motion blur and blur phenomena. Besides, a black insertion technology (BIT) is the other improvement method. Generally, data insertion and backlight insertion are two methods used in the black insertion technology. In data insertion method, LCD alternatively or allocated displays a normal data frame and black data frame within a frame interval, which is disclosed by Japan patent publication number JP2003-295835. Besides, in Japan patent publication number JP2003-108104, the normal data frame and black data frame are allocated displayed within the frame interval that two gate pulses are utilized to display the normal data frame and the black data frame. Furthermore, in Japan patent publication number JP2000-122596, four or more gate pulses are utilized to display one normal data frame, one black data frame, the next normal data frame and other black one.

The black insertion technologies implemented by the various publications aforementioned improve the motion blur or blur phenomena by sacrificing the whole screen brightness and the response time of liquid crystals. Moreover, these general black insertion technologies aforementioned do not consider the characteristic response time of liquid crystals. FIG. 3 is a diagram illustrating the wave characteristics of response time for liquid crystals in a black insertion technology. During a first display period T1 within a frame interval Tf, liquid crystals are not ready for a suitable gray level (shown as point H) and in the meantime a black data frame is inserted in a second display period T2, which results in all frames displayed with the inadequate gray levels beyond requirements and displays the frames deviated from the target ones. That is, when compared with a general LCD without black insertion technology, the LCD with black insertion technology improves the blur phenomenon and displays sharper texts, but sacrifices whole luminance and color, such as displayed red deviated from original red, etc. These drawbacks aforementioned in black insertion technology are due to no consideration on the response time of liquid crystals.

### SUMMARY OF THE INVENTION

It is an object of the present invention to provide a driving method of LCD by scanning twice within a frame interval. For displaying in good qualities, the necessary time for liquid crystals to be twisted to a predetermined angle for a target gray level or for a black gray level from any gray level is under consideration.

It is one of objects of the present invention to provide a driving apparatus for a LCD by using ASIC. The driving method with black insertion technology is implemented by retrieving and comparing frame data stored in a memory with a look-up table for acquiring an over-driving voltage curve, selecting a scanning method associated with the over-driving voltage curve and outputting frames, which may reduce hardware cost for black insertion technology.

According, one embodiment of the present invention is provided with a method for driving liquid crystal display. A first scan is performed within a frame interval with applying an over-driving voltage on liquid crystals, wherein the liquid crystals are twisted to an angle for a predetermined gray level in a first display period. A second scan is performed within the frame interval with applying a black-data voltage corresponding to a black frame in a second display period, wherein the first display period and the second display period are shorter than the frame interval, respectively and modulated to have a summary equal to thee frame interval.

Moreover, apparatus for driving a liquid crystal display is provided. A memory is configured for storing pixel data for a frame. A read-only memory is configured for storing a look-up table, wherein the look-up table provides a characteristic curve of over-driving voltage for the liquid crystal display. An application specific integrated circuit is configured for electrically connecting the memory and the read-only memory, wherein the application specific integrated circuit controls displaying the frame from one of two scans in a frame interval.

### BRIEF DESCRIPTION OF THE DRAWINGS

FIG. 1 is a schematic diagram illustrating a display on a general CRT with a pulse type in accordance with a prior art.

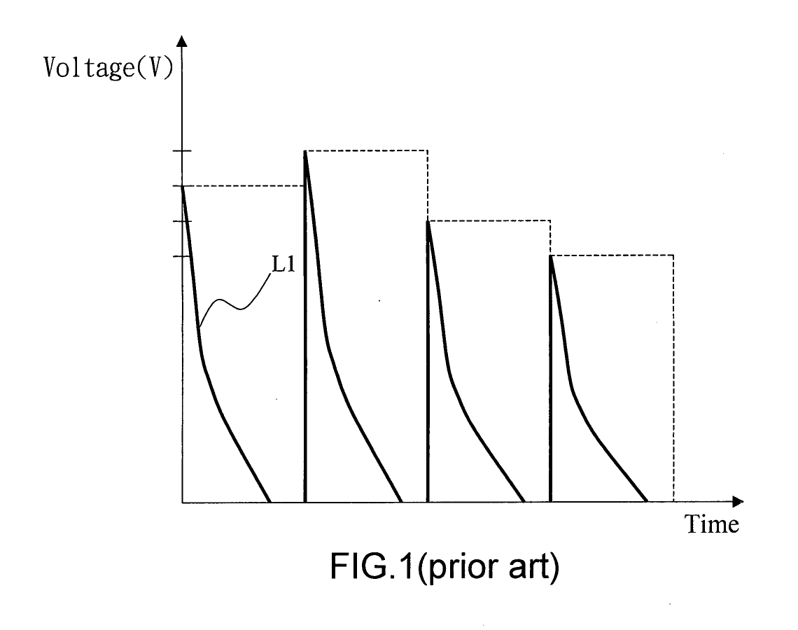

FIG. 2 is a schematic diagram illustrating a display on a general LCD with a hold type in accordance with a prior art.

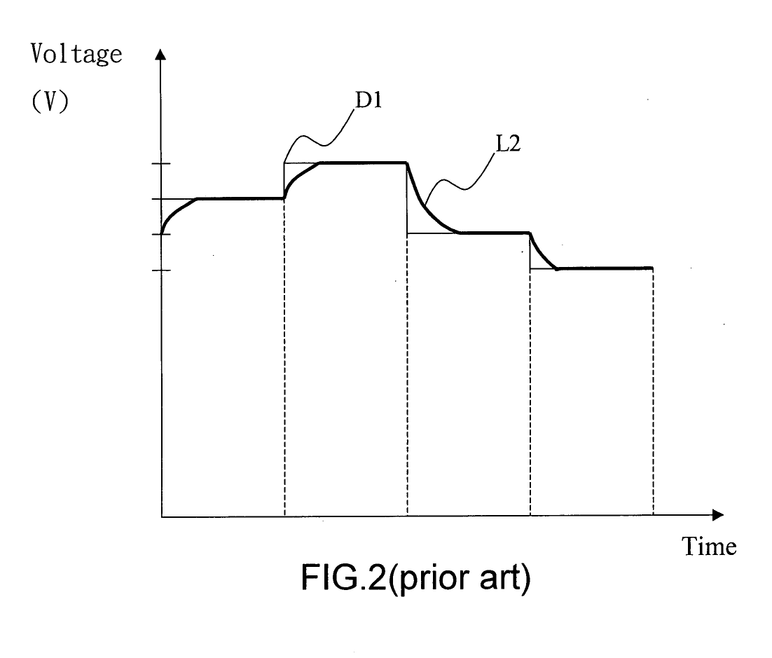

FIG. 3 is a schematic diagram illustrating a characteristic response condition of liquid crystals for a LCD utilizing black insertion technology in accordance with a prior art.

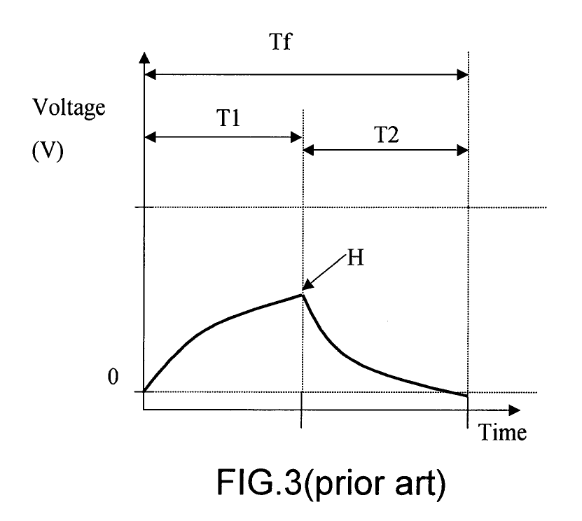

FIG. 4 is a schematic diagram illustrating a characteristic response condition of liquid crystals for a LCD utilizing black insertion technology in accordance with one embodiment of the present invention.

FIG. 5 is a schematic diagram illustrating displaying for a LCD utilizing black insertion technology in accordance with one embodiment of the present invention.

FIG. 6 is a schematic diagram illustrating a characteristic response condition of liquid crystals for a LCD utilizing black insertion technology in accordance with the other embodiment of the present invention.

FIG. 7 is a schematic diagram illustrating one scanning method for the embodiment in FIG. 6.

FIG. 8 is a schematic diagram illustrating another scanning method for the embodiment in FIG. 6.

FIG. 9 is a schematic diagram illustrating a characteristic response condition of liquid crystals for a LCD utilizing black insertion technology in accordance with one embodiment of the present invention.

FIG. 10 is a schematic diagram illustrating one scanning method for the embodiment in FIG. 9.

FIG. 11 is a schematic diagram illustrating another scanning method for the embodiment in FIG. 9.

FIG. 12 is a schematic block diagram illustrating an exemplary driving apparatus of a LCD with impulse type in accordance with the present invention.

### DETAILED DESCRIPTION OF THE INVENTION

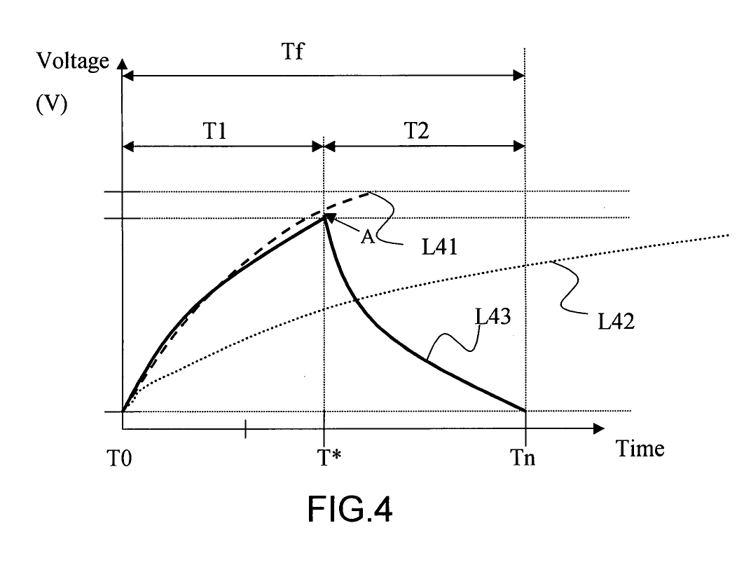

FIG. 4 is a schematic diagram illustrating the driven mode of single pixel for a liquid crystal display in accordance with one embodiment of the present invention. Shown in FIG. 4, L42 is a characteristic curve in response to liquid crystals of a panel, and L41 is another characteristic curve in response to the liquid crystals driven by an over-driving voltage. In one embodiment, an identical pixel is scanned twice within a frame interval Tf (from T0 to Tn). A suitable characteristic curve in response to a selected over-driving voltage is selected under the consideration of response characteristics of the liquid crystals for the first scan. The liquid crystals are twisted to an angle for a predetermined gray level from the start of the first scan T0 to a time scale T* (a first display period is T1). That is, the point on L43 reaches or approaches to the voltage A on the time scale T*. Next, the second scan is performed from the time scale T* by employing a black-data voltage corresponding to a black frame. Thus, the liquid crystals are twisted to reach to a black gray level from the predetermined gray level from the start of the second scan T* to an end Tn (a second display period is T2). Accordingly, the summary of the first display period T1 and the second display period T2 is equal to the frame interval Tf. That is, the two scans are performed within the frame interval Tf, which does not change single frame interval Tf. Furthermore, according to the spirit of the present invention, the time for the twisting of the liquid crystals may be adjustable in accordance with the characteristics of the liquid crystals. That is, the time scale T* may be any point within the frame interval Tf and liquid crystals are twisted to the angle for a target gray level on the time scale T*. In the case of long time for twisting the liquid crystals to the target (predetermined) gray level, the time scale T* maybe shifted to provide a longer first display period T1 for sure that the liquid crystals are twisted to the required angle. In the case of long time for twisting the liquid crystals from any gray level to a black gray level, the time scale T* maybe shifted to provide a longer second display period T2 for sure that the liquid crystals are twisted to the black gray level from any gray level.

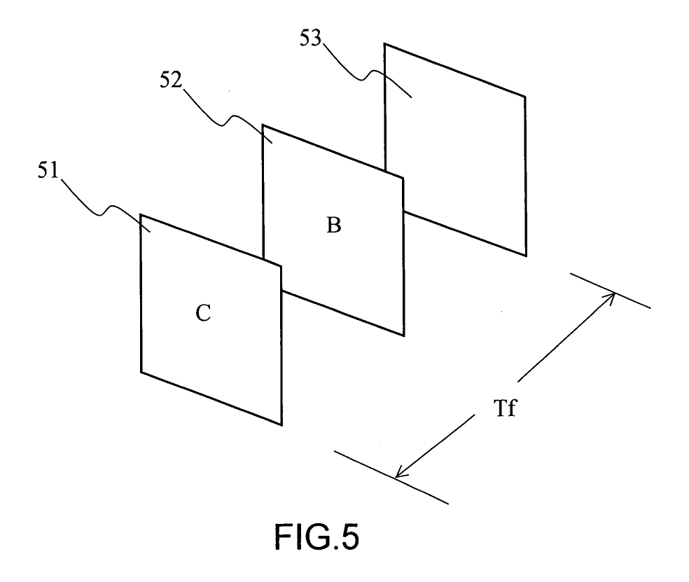

Accordingly the spirit of the present invention, following figures illustrate that a frame is displayed during a frame interval in accordance with the present invention. Shown in FIG. 5, a current frame is inputted in company with the first scan at the beginning of the frame interval. A frame 51 presents the current frame data (C) at the start (T0 shown in FIG. 4) of the frame interval Tf.

Next, black frame data (B) is inputted in company with the second scan at or approaching time scale T*. A frame 52 presents to display the black frame data at or after the time scale T*, and a frame 53 is displayed in the end of the frame interval Tf and the next frame is ready for displaying. The scanning method in FIG. 5 may be applied when the display period of the current frame data is almost equal to the display period of the black frame data, that is, the time for liquid crystals to be twisted to a target or predetermined angle is almost equal to one for them to be twisted from any predetermined angle to the angle for a black gray level.

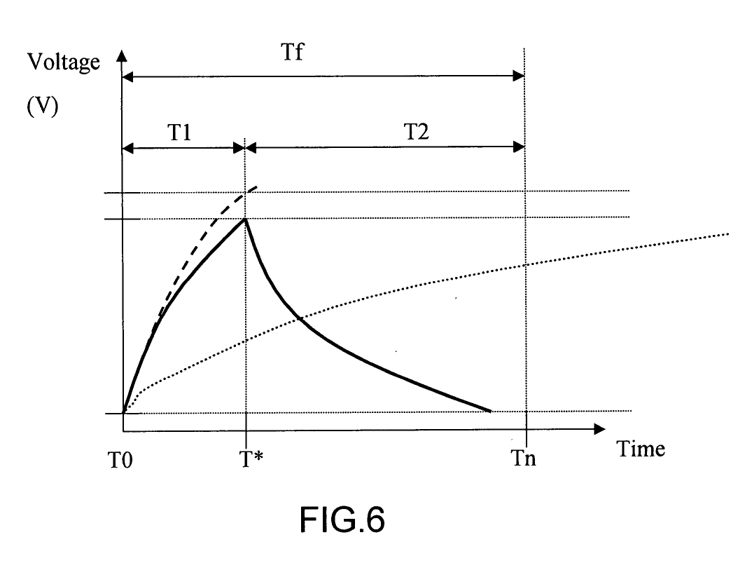

FIG. 6 is another condition of FIG. 4. In case it spends the liquid crystals longer time to be twisted from any predetermined angle to the angle for a black gray level, the second display period T2 may be modulated to set the second display period T2 longer than the first display period T1. In the case, a higher over-driving voltage is selected for the first scan to enable the liquid crystals to be twisted to a target angle within the time scale T* shorter than 8 ms. Thus, during the second scan, the liquid crystals may have enough time to be twisted to the angle for the black frame data from the target angle.

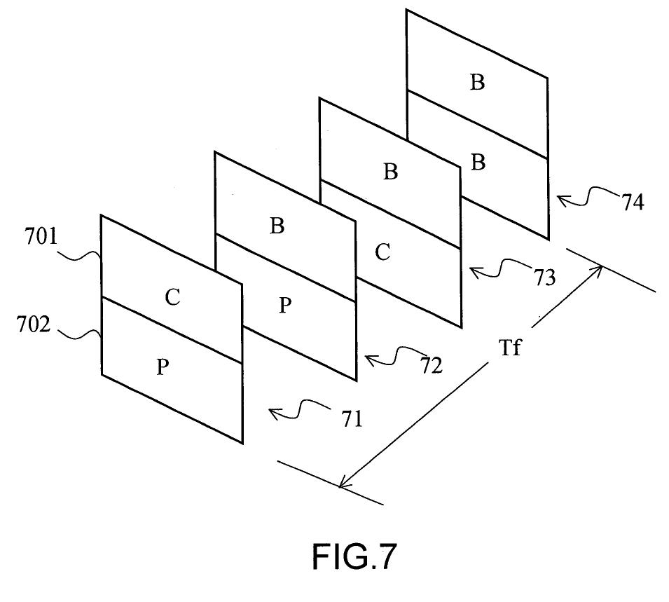

Furthermore, in the case of the first display period T1 shorter than the second display period T2, FIG. 7 illustrates the scan method in company with two driving integrated circuits (ICs) (not shown) in accordance with one embodiment of the present invention. A frame is divided into two blocks 701 and 702 that are driven by two different ICs, respectively. The first scan is executed at the beginning of the frame interval and applied from the block 701.

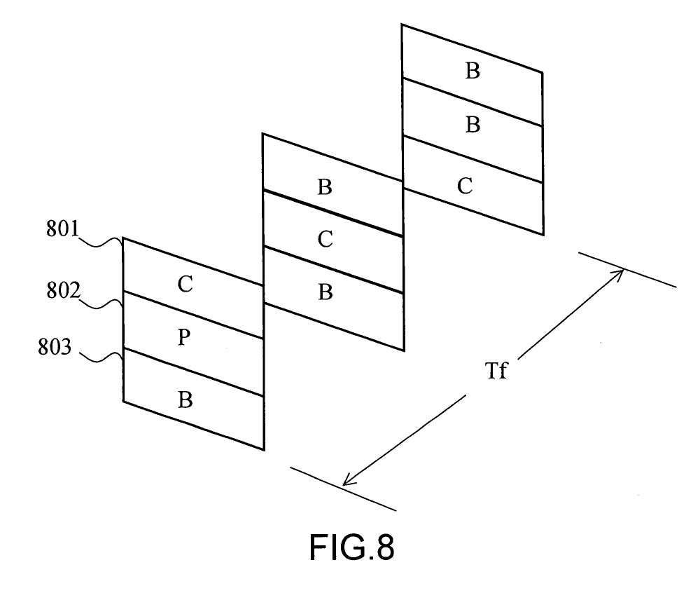

A frame 71 presents the block data of a current frame (C) shown in the block 701 and the block data of a previous frame (P) shown in the block 702 at or near the start of the first scan T0 of the frame interval Tf. Next, the second scan is executed at the time scale T* to input the block data of a black frame to the block 701. In the meanwhile, the first scan is applied on the block 702 and the another block data of the current frame is inputted into the block 702. A frame 72, at the time scale T*, presents the block data of the black frame (B) shown in the block 701 and the block data of the previous frame (P) shown in the block 702 that is ready for display the another block data of the current frame. Next, a frame 73 presents the block data of the black frame (B) last on the block 701 and the another block data of the current frame (C) shown in the block 702. When near the end of the frame interval Tf (time scale Tn of the FIG. 4), the second scan is applied on the block 702. A frame 74 presents the black frame shown both in the blocks 701 and 702. Accordingly, the two driving ICs are configured to perform the two scans onto the respectively controlled blocks, so as to provide the liquid crystal for each block enough time to be twisted to the angle for a black gray level from any predetermined gray level. FIG. 8 illustrates an exemplary scanning method in company with three ICs. A frame is divided into two blocks 801, 802 and 803 that are driven by three different ICs, respectively. The scanning method in the embodiment is similar to one in FIG. 7 and is not illustrated herein.

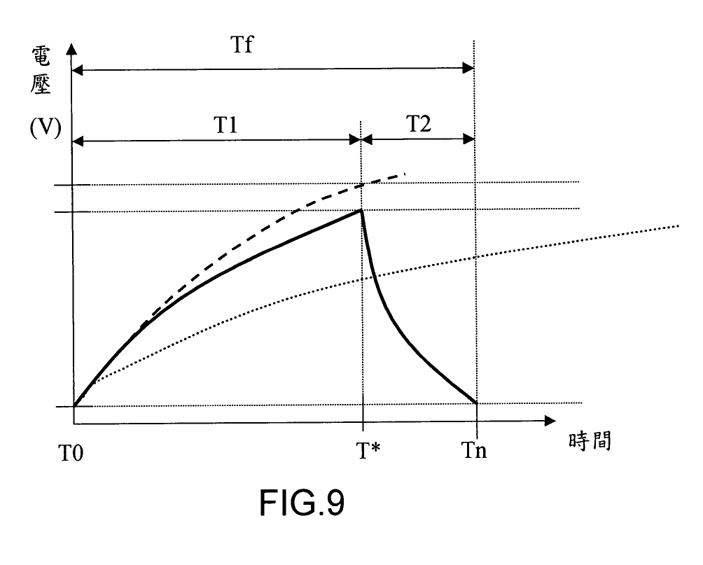

FIG. 9 is another condition of FIG. 4, In case it spends the liquid crystals shorter time to be twisted from any predetermined angle to the angle for a black gray level, the first display period T1 may be modulated to set the first display period T1 longer than the second display period T2. In the case, a lower over-driving voltage is selected for the first scan to enable the liquid crystals to be twisted to a target angle within the time scale T* longer than 8 ms. Thus, during the first scan, the liquid crystals may have enough time to be twisted to the predetermined angle for the target gray level.

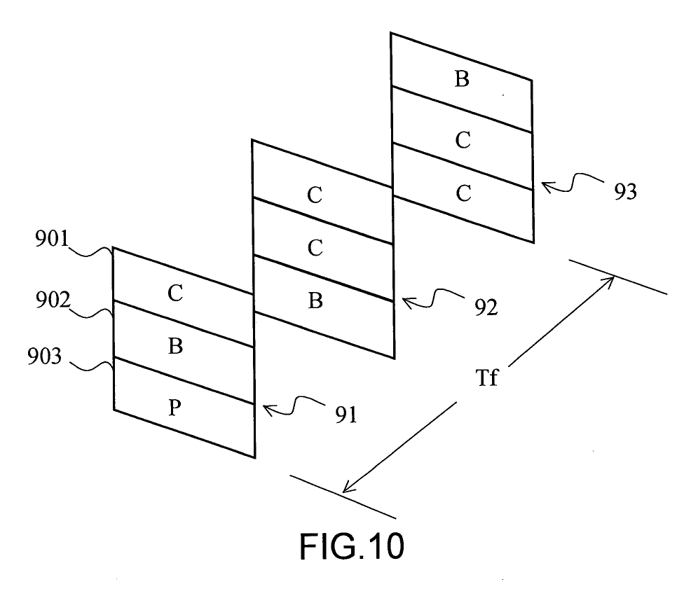

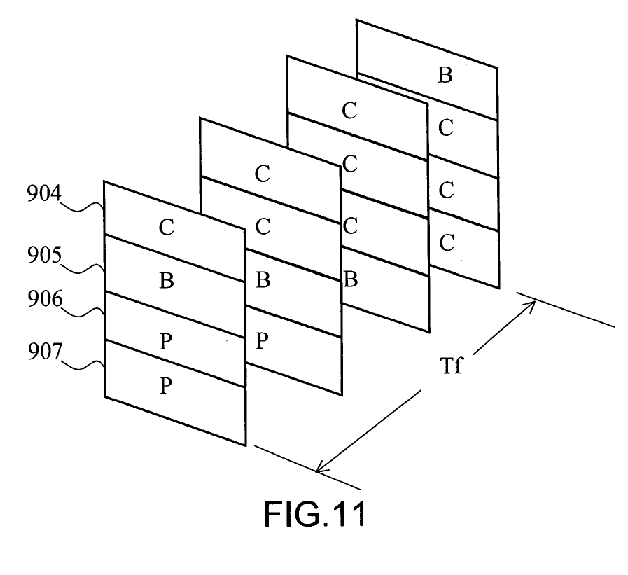

Furthermore, in the case of the first display period T1 longer than the second display period T2, FIG. 10 illustrates the scan method in company with three driving integrated circuits (ICs) in accordance with one embodiment of the present invention. A frame is divided into three blocks 901, 902 and 903 that are driven by three different ICs (not shown), respectively. The first scan is executed at the beginning of the frame interval and applied from the block 901. A frame 91 presents the block data of a current frame (C) shown in the block 901, the block data of the black frame (B) in the block 902 and the block data of a previous frame (P) shown in the block 903 at or near the start of the first scan T0 of the frame interval Tf. When the first scan is applied on the block 902, a frame 92 presents the block data of the current frame (C) shown in the blocks 901 and 902, and the block data of the black frame (B) in the block 903. After the second scan applied on the block 901 and when near the end of the frame interval Tf (time scale Tn of the FIG. 4), a frame 93 presents the respect block data of the current frame (C) shown both in the blocks 902 and 903, and the block data of the black frame (B) shown in the block 901. Accordingly, the three driving ICs are configured to perform the two scans onto the respectively controlled blocks, so as to provide the liquid crystals for each block enough time to be twisted to the predetermined angle for the target gray level. FIG. 11 illustrates an exemplary scanning method in company with four ICs. A frame is divided into four blocks 904, 905, 906 and 907 that are driven by four different ICs, respectively. The scanning method in the embodiment is similar to one in FIG. 10 and is not illustrated herein.

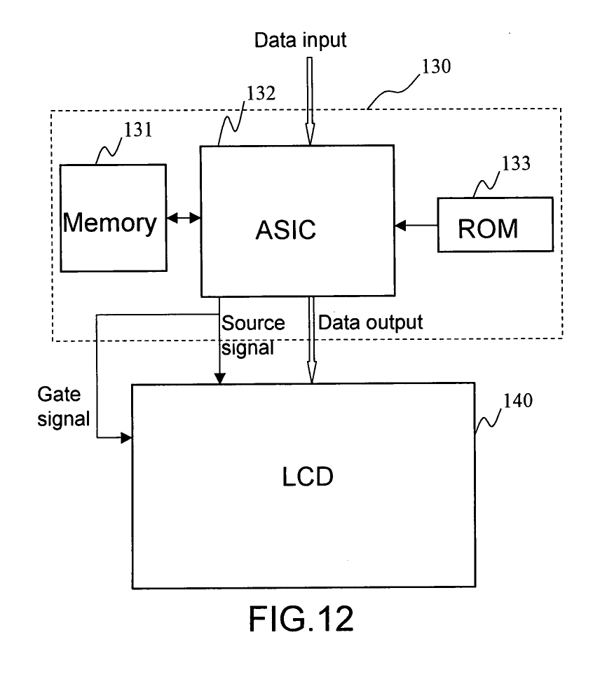

FIG. 12 is a schematic block diagram illustrating the exemplary driving apparatus of a liquid crystal display in accordance with the present invention. In one embodiment, impulse-mode driving apparatus 130 includes: a memory 131 memory storing pixel data for a frame; a read-only memory 133 storing a look-up table that provides a characteristic curve of over-driving voltage for said liquid crystal display; and an application specific integrated circuit 132 (ASIC) electrically connecting the memory 131 and the read-only memory 133. The application specific integrated circuit 132 generates a timing control signal, such as dot clock signal, to control the execution of twice scan within the frame interval Tf for a liquid crystal display 140. An over-driving voltage is applied on the liquid crystals to reduce the response time of the liquid crystals. Thus, in the first display period T1, the liquid crystals may be twisted to the predetermined angle for displaying corresponding gray level required in the frame interval Tf. The second scan starts at the time scale T* and a voltage corresponding to the black data is applied in the second display period T2. It is noted that the first display period T1 and the second display period T2 may be modulated to have a summary equal to the frame interval Tf, that is, the time scale T* may be shifted.

Furthermore, in the embodiment, the memory 131 may be a synchronous dynamic random access memory or double-data-rate synchronous dynamic random access memory configured for storing pixel data for a frame. The read-only memory 133 is an electrically erasable and programmable ROM (EEPROM) configured for the look-up table for over-driving mode. The application specific integrated circuit 132 processes the frame data to acquire a characteristic curve of over-driving voltage, controls the scanning methods, and providing the data of back frame and relative controlling signals for the implement of impulse-mode driving method.

Accordingly, the over-driving method associated with black frame insertion technology in the present invention may generate the effect of target gray level on consideration to the response time of the liquid crystals from any gray level to the black gray level. Such an integrated method applied to a TFT-LCD may enhance display qualities for the TFT-LCD. Furthermore, ASIC may be used for processing the characteristic curve of over-driving voltage, controlling the scanning methods and providing the data of back frame and relative controlling signals, which may efficiently implement the black frame insertion technology to reduce hardware costs.

Although the present invention has been explained in relation to its preferred embodiment, it is to be understood that other modifications and variation can be made without departing the spirit and scope of the invention as hereafter claimed.

What is claimed is:

1. A driving method for a liquid crystal display, comprising:
performing a first scan within a frame interval with applying an over-driving voltage on liquid crystals, wherein the liquid crystals are twisted to an angle for a predetermined gray level in a first display period; and
performing a second scan within said frame interval with applying a black-data voltage corresponding to a black frame in a second display period, wherein said first display period and said second display period are shorter than said frame interval, respectively and modulated to have a summary equal to said frame interval.

2. The driving method for a liquid crystal display according to claim 1, wherein the step of performing said first scan comprises inputting a plurality of block data of a current frame in different time scales by a plurality of driving integrated circuit.

3. The driving method for a liquid crystal display according to claim 2, wherein the step of performing said second scan comprises inputting a plurality of block black data in different time scales by a plurality of driving integrated circuit, and wherein said black frame comprises said plurality of block black data.

4. The driving method for a liquid crystal display according to claim 1, wherein the step of performing said first scan comprises inputting a current frame within said frame interval by a plurality of driving integrated circuit.

5. The driving method for a liquid crystal display according to claim 4, wherein the step of performing said second scan comprises inputting said black frame within said frame interval by said plurality of driving integrated circuit.

6. The driving method for a liquid crystal display according to claim 1, wherein said first display period is equal to said second display period.

7. The driving method for a liquid crystal display according to claim 1, wherein said first display period is shorter than said second display period.

8. The driving method for a liquid crystal display according to claim 1, wherein said first display period is longer than said second display period.

9. The driving method for a liquid crystal display according to claim 1, wherein the step of performing said second scan comprises twisting the liquid crystals to reach to a black gray level from said predetermined gray level.

10. Apparatus for driving a liquid crystal display, comprising:
a memory storing pixel data of a frame;
a read-only memory storing a look-up table, wherein said look-up table provides a characteristic curve of over-driving voltage for said liquid crystal display; and
an application specific integrated circuit electrically connecting said memory and said read-only memory, wherein said application specific integrated circuit controls displaying said frame from one of two scans in a frame interval.

11. The apparatus for driving a liquid crystal display according to claim 10, wherein said memory is a synchronous dynamic random access memory.

12. The apparatus for driving a liquid crystal display according to claim 10, wherein said memory is a double-data-rate synchronous dynamic random access memory.

13. The apparatus for driving a liquid crystal display according to claim 12, wherein said read-only memory is an electrically erasable and programmable read-only memory.

14. The apparatus for driving a liquid crystal display according to claim 10, wherein said application specific integrated circuit comprises inputting and controlling displaying a black frame from another one of scanning twice in said frame interval.

15. The apparatus for driving a liquid crystal display according to claim 10, wherein said application specific integrated circuit displays said frame according to said characteristic curve of over-driving voltage.
